(19) United States
(12) Patent Application Publication
(10) Pub. No.: US 2010/0282922 A1
(43) Pub. Date: Nov. 11, 2010

(54) MULTIFACETED TRIVET

(75) Inventor: Tara McConnell, Chester, NY (US)

Correspondence Address: SCHMEISER OLSEN & WATTS, 18 E UNIVERSITY DRIVE, SUITE # 101, MESA, AZ, 85201, US

(73) Assignee: CSA, INC., Chester, NY (US)

(21) Appl. No.: 12/776,942

(22) Filed: May 10, 2010

Related U.S. Application Data
(60) Provisional application No. 61/177,139, filed on May 11, 2009.

(51) Int. Cl. A47G 23/00; A47J 43/00

(52) U.S. Cl. 248/145.6; 248/346.01

(57) ABSTRACT

A multifaceted trivet with multifaceted functionality includes a trivet within a basket, a trivet that may serve as a lid and/or a cutting board and a trivet with a rotatable base. The trivet within a basket provides further insulation by use of the basket. The basket has serving handles which allows a heated item to be placed within the basket and easily carried to a serving area. The trivet serves as a lid that may also function as a trivet on which a serving dish or container may be placed. The trivet may fit as a lid of a particular container. The trivet may comprise a rotatable base which may be rotated for greater access to a serving dish. The trivet with a rotatable base may further include a basket having wheels for placing the trivet within to carry the trivet and the serving dish.

This application claims priority to U.S. Provisional Patent Application entitled “MULTIFACETED TRIVET,” Ser. No. 61/177,139, filed May 11, 2009, now pending, the disclosure of which is hereby incorporated entirely herein by reference.

### BACKGROUND OF THE INVENTION

1. Field of the Invention

The present invention relates generally to trivets. More specifically, the invention is a multifaceted trivet having a plurality of uses.

2. Description of the Related Art

Given the state of modern cooking and the preference to have a certain level of economy for the clean up, it is common to utilize the same containers for cooking, heating and serving. Accordingly, it is often the case that a hot cooking container is not placed on the dining table for serving purposes to prevent burning or marking of the table. There is wide spread usage of trivets. Trivets come in a variety of configurations and materials which have one common purpose of insulating hot containers from the surface upon which they are placed. Accordingly, trivets have a certain level of heat resistance so that the top surface upon which a container is placed may be kept heat safe. Depending on the material used for the trivets and the trivet configuration, it is common for the trivet to be heat safe in a range of 320° to 675° Fahrenheit.

Additionally trivets may have legs which lift them off the surface of the table on which they are placed. This separation acts as further insulation to prevent damage to the tabletop. However, some trivets are also mat like and may be laid flat upon the table surface with the heated container placed on top. Often such mat-like-trivets are made of highly insulated material such as ceramic in order to be usable with extremely hot containers.

Another challenge which is often faced when serving hot containers is the movement of the container from the kitchen area to the serving area. Often potholders are used to handle these containers; however it is not uncommon for potholders to fail to provide a sufficient grip or not fully cover the heated surface which can result in injury to the server and others should the container be dropped. In addressing this issue, it is common to use serving trays of various types which have handles that are sufficiently removed from the heated container to allow the server to deliver the heated container to the serving table. Often these serving trays are placed right on the table and also functioned to insulate the heated container from the tabletop.

While trivets are very useful for their intended purpose unfortunately due to the fact that they have only a singular usage purchasers often do not wish to buy a large number of trivets. Furthermore, since space is almost always an issue in kitchens, the number of trivets is often kept to a minimum. The difficulty with this is that when making a large meal, with numerous hot items one may find they do not have a sufficient number of trivets to meet their needs.

Ideally, a multifaceted trivet should provide a multi-purpose food preparation, food storage and food serving device that may be manufactured at a modest expense. Thus, a need exists for such a multifaceted trivet to avoid the above-mentioned problems.

### BRIEF SUMMARY OF THE INVENTION

The present invention provides for a trivet with multifaceted functionality including a trivet within a basket, the basket providing further insulation, wherein the basket has serving handles which allows a heated item to be place within the basket and easily carried to a serving area; a trivet that may serve as a lid on which a pot or container may be placed or which may fit as a lid of a particular pot or container; and a trivet having a rotatable base.

One aspect of the present invention may include a multifaceted trivet comprising a basket having a bottom surface, sidewalls and an opening, wherein the bottom surface includes a predetermined size and shape and handles coupled to opposing sidewalls of the basket. The multifaceted trivet may further comprise feet coupled to a bottom side of the bottom surface of the basket, the feet raising the bottom surface a predetermined distance, and a trivet removably coupled to the bottom surface of the basket. The size and shape of the bottom surface of the basket corresponds to the size and shape of the trivet such that there is no substantial movement of the trivet once it is in the basket. This combination of features allows not only for convenience in serving but also economy in space usage which is often important in a kitchen setting.

Another aspect of the present invention may include a multifaceted trivet comprising a body portion having a top surface, a bottom surface and a lip around the outer periphery of the body portion and handle(s) integral with the top surface of the body portion. The multifaceted trivet may include feet coupled to the bottom surface of the body portion, the feet lifting the body portion a predetermined distance. The multifaceted trivet is moveable between a position as a lid on a serving dish with the lip resting on sidewalls of the dish and the feet fitting within the dish and a position as a trivet with the feet resting on a serving surface and the dish resting on the top surface of the body portion. The feet may generally be made out of some type of heat resistant material so that if the serving dish and trivet cover are heated the feet will not retain the heat, thus allowing them to be placed upon the table surface.

Yet another aspect of the present invention may include a multifaceted trivet comprising a trivet having a top surface and a bottom surface, wherein the top surface supports a serving dish. The multifaceted trivet may further include a rotatable base coupled to the bottom surface, the rotatable base rotating to provide access to the serving dish by various users. In particular embodiments and for increased versatility, the trivet with a rotatable base may comprise a basket to aid in the transport of the trivet and any heated serving dish resting thereon. The basket may also be configured with wheels that further enable movement of the trivet with any heated serving dish about the serving surface. It should be appreciated that the trivet of the subject invention could be of any preferred shape or dimensions.

Yet another aspect of the present invention may include a multifaceted trivet comprising a trivet having a top surface and a bottom surface, wherein the top surface further comprises a cutting board for use in food preparation.

The present invention holds significant improvements and serves as a multifaceted trivet. These and other features, aspects, and advantages of the present invention will become better understood with reference to the following drawings and description.

### BRIEF DESCRIPTION OF THE DRAWINGS

FIG. 1 is a perspective view of a multifaceted trivet within a basket in accordance with the present invention.

FIG. 2 is a perspective view of a multifaceted trivet removed from a basket in accordance with the present invention.

FIG. 3 is a prospective view of a multifaceted trivet that may serve as a lid and a cutting board in accordance with the present invention.

FIG. 4 is a cross-sectional view taken along lines 4-4 of FIG. 3 of a multifaceted trivet that may serve as a lid and a cutting board in accordance with the present invention.

FIG. 5A is side plan view of a multifaceted trivet serving as a lid on a serving dish in accordance with the present invention.

FIG. 5B is side plan view of a multifaceted trivet serving as a trivet supporting a serving dish in accordance with the present invention.

FIG. 6 is a side elevation view, partially exploded, showing a trivet with a rotatable central support in accordance with the present invention.

FIG. 7 is a perspective view of a trivet with a rotatable base in accordance with the present invention.

FIG. 8 is a top plan view of one embodiment of a trivet with a rotatable base as an oval.

FIG. 9 is a top plan view of another embodiment showing a trivet with a rotatable base in a circular configuration in accordance with the present invention.

FIG. 10 is an exploded view of a wheel of a trivet with a rotatable base in accordance with the present invention.

FIG. 11 is a prospective view of an alternate embodiment of a rotatable base in accordance with the present invention.

FIG. 12 is a prospective view of a multifaceted trivet that may serve as a lid in accordance with the present invention.

FIG. 13 is a cross-sectional view taken along lines 4-4 of FIG. 12 of a multifaceted trivet that may serve as a lid in accordance with the present invention.

The various embodiments of the present invention will hereinafter be described in conjunction with the appended drawings, wherein like designations denote like elements.

### DETAILED DESCRIPTION

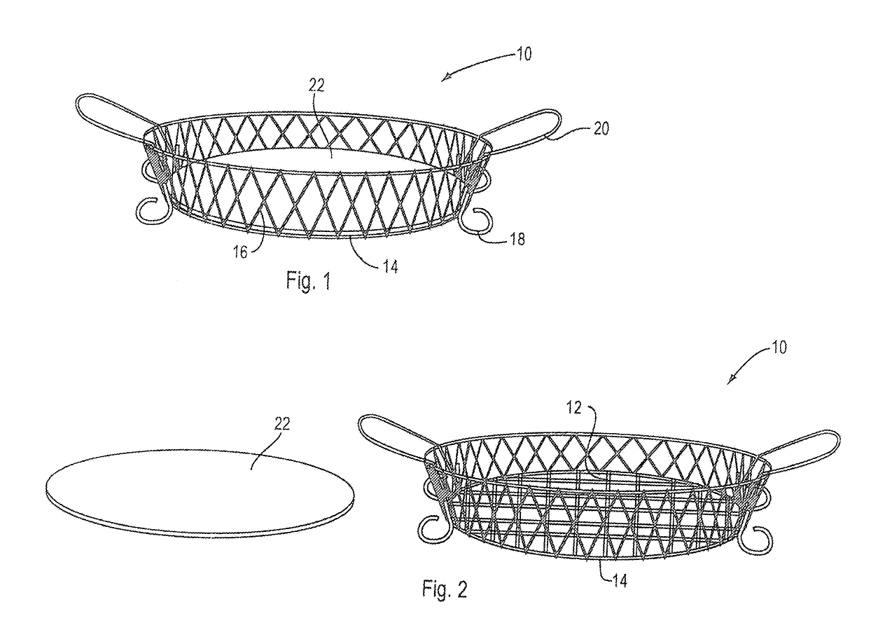

Referring now to FIG. 1, illustrating a perspective view of a multifaceted trivet 22 within basket 10 in accordance with the present invention.

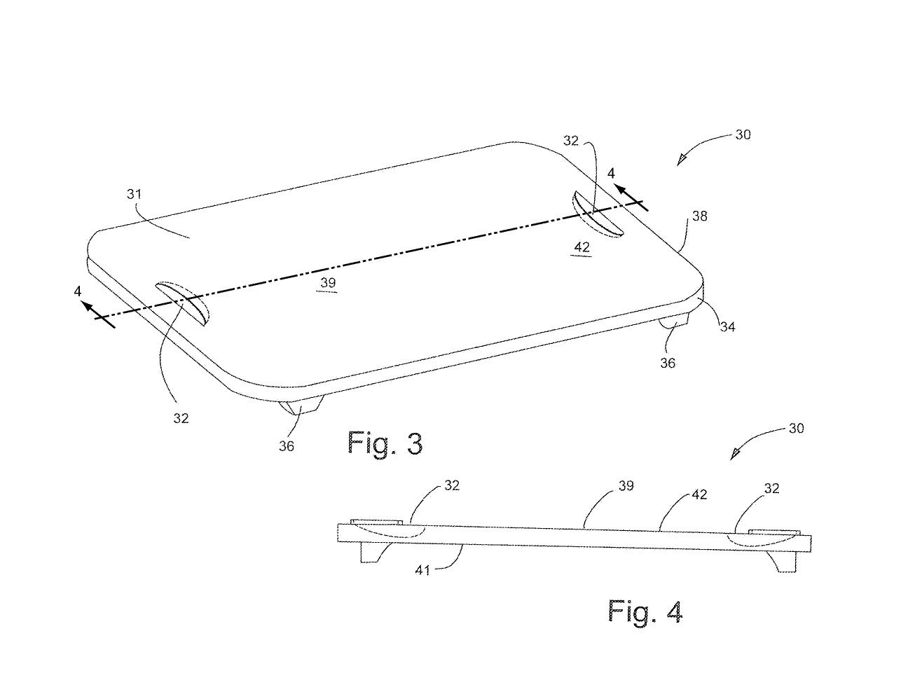

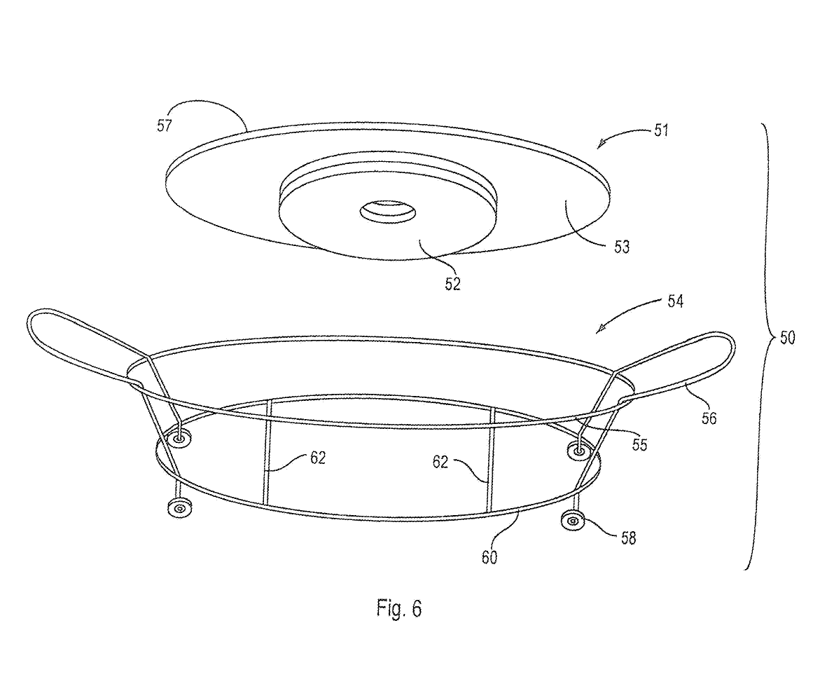

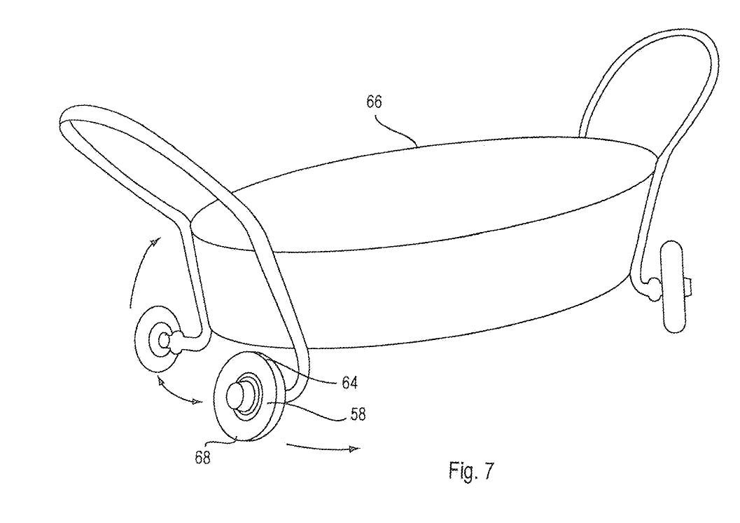

The present invention relates to trivets 22 with multifaceted functionality including trivet 22 within basket 10, as shown. Basket 10 provides insulation, and comprises serving handles 20 which allow a heated item to be placed within basket 10 and easily carried to a serving area. Trivet 22 may serve as a lid on which a pot or container may be placed or which may fit as a lid of a particular pot or container. Trivet 22 may also serve as a cutting board 39, as shown in FIGS. 3 & 4. Trivet 22 may also have a rotatable base 52, as shown and discussed in FIG. 6.

Particular embodiments of the present invention relate to the basket 10, and trivet 22 combinations. Basket 10 may be formed of a wire grid 12, as shown in FIGS. 1 and 2. This wire grid 12 forms sufficient support across bottom surface 14 to allow basket 10 to be used as a container for fruits or the like. Basket 10 has sidewalls 16 which may also comprise wire. It should be appreciated that while particular embodiments disclose a wire basket, other materials besides wire could be used. For example, and without limitation, basket 10 could be made of wood, plastic, ceramic or any other material which has sufficient structural integrity to hold fruit or like items. Basket 10 may also have an opening, wherein a serving dish may be placed within basket 10, through the opening, and retained within basket 10 by sidewalls 16 and bottom surface 14. Basket 10 may also have feet 18 which serve to raise bottom surface 14 off any serving surface a predetermined distance. This predetermined distance provides an air gap to prevent surface contact between serving dish 46 and the table. In this manner the present invention protects the table from convective and radiant heat that may alter the surface characteristics. On opposite sides of basket 10 and secured to sidewalls 16 may be handles 20 which allow basket 10 to be carried, used as a serving tray for hot items. It will be understood that handles 20 may be made from any appropriate material and further, that they may also be insulated.

Bottom surface 14 of basket 10 may have a predetermined size and shape which may be of any desired configuration. The configuration may be, but is not limited to circular, oval, elongate or any other configuration that would be desirable for its intended usage. In one particular embodiment as shown in FIGS. 1 and 2, bottom surface 14 is circular. The size and shape of bottom surface 14 of basket 10 may correspond to the size and shape of trivet 22. This correspondence of size and shape substantially prevents movement of the trivet 22 once coupled to bottom surface 14 of basket 10. Trivet 22 may be moveable between a first position coupled to bottom surface 14 of basket 10; with basket 10 resting on a serving surface, and a second position with trivet 22 removed from basket 10 and used separately resting on the serving surface. In this particular embodiment, trivet 22 may be used to either line basket 10 or may be removed and used separately. In particular embodiments, the use of trivet 22 in either the first position or the second position may depend upon the heat of the serving dish. For example, and without limitation, trivet 22 may be moved to the first position when a serving dish has heat greater than a heat that can be used with trivet 22 in the second position. This configuration allows the server to determine whether the heat of the serving dish is so high as to require trivet 22 to remain within basket 10 in a first position and obtain the additional benefit of having basket 10 bottom surface 14 lifted off the serving surface by feet 18 or whether the heat would be sufficiently reduced by trivet 22 alone if placed directly on the serving surface.

Trivet 22 may be made of any suitable material which is heat-safe to a desired degree. For example, trivet 22 may comprise fern, rattan, ceramic, PVC and/or any other similar material which is heat resistant. It should also be appreciated that trivets 22 can be made in many different colors to provide a variety for the table setting.

In embodiments where trivet 22 comprises rattan, there may be an outer circumference which is thicker than the remaining portions of trivet 22 so as to at least partially lift trivet 22 from the tabletop and provide air space even when the container is placed upon trivet 22 only.

Referring now to FIGS. 3 and 4 showing trivet 30 in accordance with another embodiment of the present invention. Trivet 30 may comprise a body portion 31 having a top surface 42, a bottom surface 41 and a lip 38. Trivet 30 may also include handle(s) 32 coupled to the top surface 42 of the trivet 30. In particular embodiments of the present invention wherein top surface 42 comprises cutting board 39, handle 32 may be substantially integrated so as to provide a substantially flat surface where food may be cut and scraped off. In this version, the user may grasp cutting board 39 by inserting fingers under handles 32 and lifting the lid upwardly away from serving dish 46. Handles 32 may comprise a ridge around the exterior of lip 38 or other means whereby a user may get a handhold to lift the potentially hot lid. In other embodiments handles 32 may be folded away into top surface 42, and moved perpendicular to top surface 42 when lifting lid. It should be appreciated that handles 32 may be located in the ends of body portion 31 or at various other locations and that this disclosure is in any way meant to be construed as limiting, rather that the particular embodiments have been disclosed to enable the present invention. Accordingly many other shapes and configurations of handles 32 are possible within the present invention. Handles 32 may also comprise insulative means and/or highly thermo-conductive material to ensure heat is dissipated efficiently, thereby allowing the user to grasp a substantially cool handle 32.

Trivet 30 may also serve as a flat surface upon which a heated container may be placed. Trivet 30, within this particular embodiment of the present invention comprises cutting board 39. Cutting board 39 provides a location whereby a user may cut and prepare food. Food may then be scraped into serving dish 46 or into another suitable container. Cutting board 39 comprises a substantially flat surface allowing the user to clean with ease. Further, trivet 30 may include feet 36 that may be coupled to bottom surface 41 at corners 34 of trivet 30. Feet 36 may hold body portion 31 of trivet 30 a predetermined distance from the surface it is set upon.

Depending upon the size of the container or serving dish 46, feet 36 may be short in nature so as to fit within the container but not interfere with the food products therein. In particular embodiments where trivet 30 may be of a large size, it may be desirable to have at least one center support 44. Center support 44 may also be bottom surface 41 of recessed handle(s) 32. If desirable, trivet 30 may have other features, including but not limited to a ledge around the periphery of the body portion 31 to prevent items from sliding off trivet 30 and, in particular embodiments, to allow trivet 30 to be used as a serving plate upon which the heated container is carried.

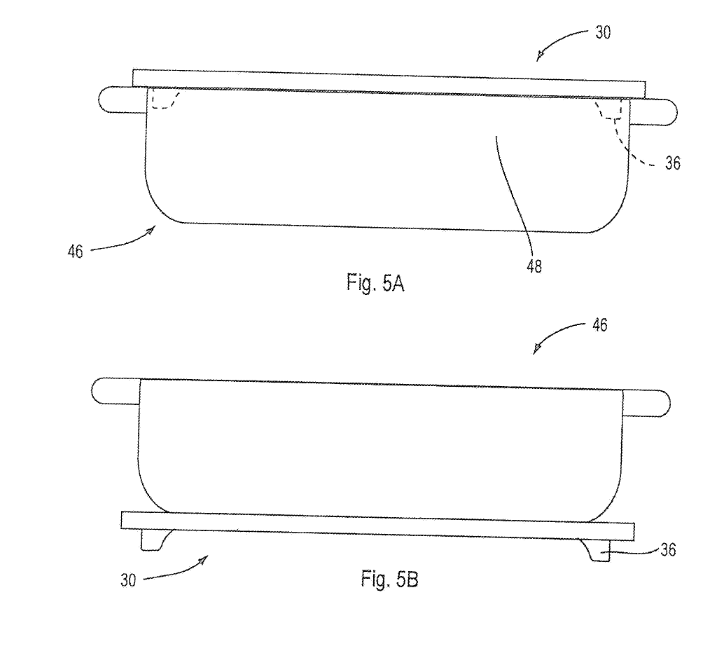

With additional reference to FIGS. 5A and 5B, lip 38 may be coupled around the outer periphery of body portion 31 of trivet 30. Lip 38 allows trivet 30 to be placed over a heated container or serving dish 46 without interference of feet 36. Trivet 30 may be moveable between a position as a lid and a position as a trivet 30 and/or cutting board 39. In the position as a lid, lip 38 may rest on sidewalls 48 of the serving dish 46, with feet 36 fitting within serving dish 46. In the position as a trivet 30, feet 36 may rest on a serving surface and further serving dish 46 may rest on trivet 30. Cutting board 39 may be used when placed on counter or other flat surface or be used when on serving dish 46. For example, if a pasta dish has been kept warm in serving dish 46 the user may decide to grate some cheese to add just before eating. The user would be able to leave the grated cheese on the top surface of cutting board 39 and add to the food just prior to eating, while keeping the food warm.

Feet 36 may be made of any material suitable for dissipation of heat so that trivet 30, even if heated with the container or serving dish 46 may be removed from its lid position and placed on the serving surface. Feet 36 may be made of a ceramic material which is substantially heat resistant or any other suitable material that would allow trivet 30 to be placed on the serving surface without marring the surface, such as silicone. Feet 36 may be heat resistant up to 675 degrees Fahrenheit and in particular embodiments, may have a higher heat resistance than body portion 31 of trivet 30.

Trivet 30 may be any shape, including but not limited to rectangular, round, oval, square, and the like. Trivet 30 may be of a size and shape corresponding to a size and shape of the serving dish, wherein trivet 30 may adequately serve as the lid of serving dish 46.

Referring now to FIG. 6 depicting multifaceted trivet 50 in accordance with particular embodiments of the present invention. Trivet portion 51 comprises top surface 57 and bottom surface 53. Trivet portion 51 may further comprise a rotatable base 52 coupled to bottom surface 53 of trivet portion 51. Top surface 57 of trivet portion 51 may support serving dish 46. Rotatable base 52 allows trivet portion 51 to be rotated and thereby allowing access to serving dish 46 by a plurality of users, for example when a plurality of users may be seated around a table. Trivet portion 51 may be placed on the table with rotatable base 52 contacting the table and supporting trivet portion 51. A heated serving dish 46 may then be placed on trivet portion 51. The plurality of users may then rotate trivet portion 51 by using rotatable base 52 to gain access to the food items within serving dish 46. This particular embodiment allows for greater accessibility to the serving dish and ease in serving the food within serving dish 46, while protecting the table from the heat of serving dish 46.

Multifaceted trivet 50 may further include basket 54 to transport trivet portion 51 and serving dish 46 supported by trivet portion 51. Basket 54 may have base 60 and top frame support 55. Basket 54 may further have handles 56 and wheels 58, as shown. Wheels 58 may be made of any suitable material including but not limited to nylon and enable movement of multifaceted trivet 50 about a serving surface. Similarly, basket 54 may be manufactured from any suitable material including but not limited to wire, which may or may not be coated. Base 60 of basket 54 may comprise supports 62. The present invention is configured such that rotatable base 52 of trivet portion 51 may be supported by base 60 and supports 62 of basket 54 so that trivet portion 51 rests substantially evenly within basket 54. The basket may be an open configuration, and as, or in an alternate embodiment could be enclosed.

Trivet portion 51 may be removed from basket 54 and placed directly on the serving surface thereby functioning also as a rotating trivet. Trivet portion 51 may be made of any suitable material for protecting the table from heat including but not limited to wood, ceramics or the like.

Referring now to FIG. 7 showing basket 54 with enlarged wheels 58 of a multifaceted trivet 50 in accordance with particular embodiments of the present invention. Wheels 58 may be slanted so that top portion 64 of wheels 58 may be closer to basket 54 than bottom portion 68 of wheels 58. By angling wheels 58, basket 54 may move in a substantially circular pattern. It should be appreciated that the shape of basket 54 may be oval, as shown in this figure, or any other desirable shape including but not limited to circular, square or rectangular.

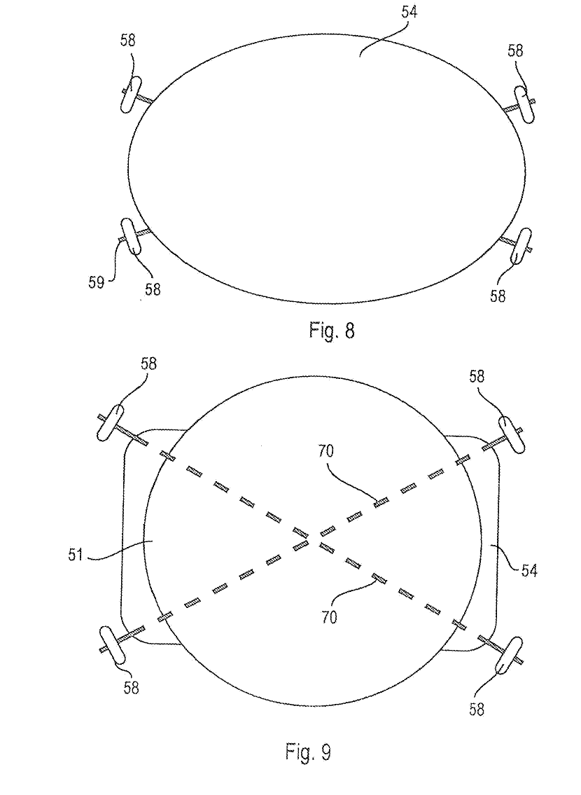

Referring now to FIG. 8 which depicts a top view of a particular wheel positioning and an oval shaped basket 54 of a multifaceted trivet 50 in accordance with the present invention. Wheels 58 may have axle 59 that is substantially aligned with axle 59 of wheel 58 on the opposite side of basket 54.

As shown in FIG. 9, another particular embodiment of basket 54 is depicted in accordance with the present invention. Basket 54 may be rectangular with intersecting supports 70. Trivet portion 51 may be circular and may have rotatable base 52, wherein trivet portion 51 is resting upon the intersecting supports 70 of basket 54. This allows either the entire basket 54 to be moved on wheels 58 or trivet portion 51 to rotate on its rotatable base 52. In these particular embodiments, basket 54 may be moved close to a user and then the use may then rotate trivet portion 51 to better access food items with serving dish 46 supported by trivet portion 51.

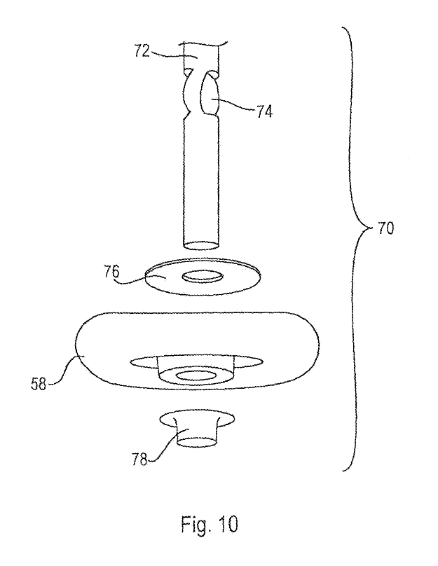

Referring now to FIG. 10 depicting a more detailed view of wheels 58 in accordance with embodiments of the present invention. The bottom portion of handle 56, as shown in FIG. 6 may extend outwardly forming axle 72. Axle 72 may have a crimped portion 74 to prevent wheel 58 from moving too far up axle 72. The construction of wheel assembly 71 may consists of washer(s) 76, which may be coupled over axle 72. Washer 76 may have an inner diameter which prevents it from moving past crimped portion 74. While any washer suitable for the purposes of this invention may be used, one possible non-limiting washer 76 includes a number 8 SAE zinc plated washer.

After washer 76 is coupled to axle 72, wheel 58 is coupled to axle 72. While wheel 58 may also be of any suitable material and size to satisfy the purposes of this invention, one possible non-limiting embodiment utilizes a ⅞^{th} inch nylon wheel. After wheel 58 is coupled to axle 72, push nut washer cap 78 is slid over the end of axle 72. This arrangement holds wheel 58 in place upon axle 72 while allowing wheel 58 to rotate. In one particular embodiment, and without limitation, push nut washer cap 78 is 3/16^{th} of an inch and is steel/zinc plated.

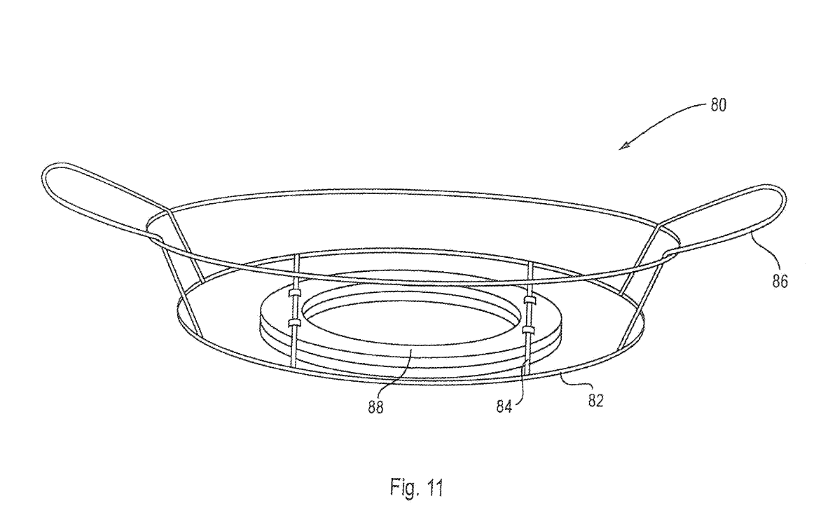

Referring now to FIG. 11 depicting an alternative embodiment of basket 80 of a multifaceted trivet 50 in accordance with the present invention. Basket 80 may comprise bottom portion 82 having supports 84. Basket 80 may further include handle 86 for carrying basket 80. Basket 80 may further include rotatable base 88 coupled to supports 84 of the basket 80. This enables the entire basket 80 and any contents therein to rotate upon base 88.

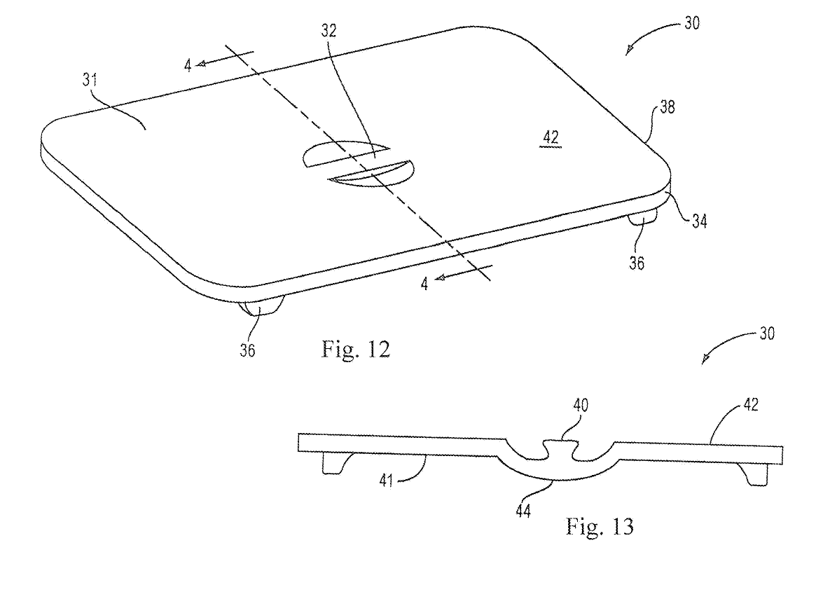

Referring now to FIGS. 12 and 13 showing prospective views of multifaceted trivet 50 that may serve as a lid in accordance with the present invention. The present figures show another embodiment of the present invention that may be employed when cutting board 39 is not used. Using this embodiment the user may insert fingers into the handle 32, squeeze fingers together and lift lid off serving dish 46. Indented portion 144 comprises substantially the same thickness as the remainder of the lid. Top surface 40 within this particular embodiment is at approximately the same height as top surface 42, as illustrated, for ease of storing when not in use and for using as trivet 30.

It will be understood that the heat resistance of multifaceted trivet 50 is dependent upon the material from which multifaceted trivet 50 is formed. Multifaceted trivet 50 may be heat resistant and used to protect a serving surface to temperatures up to 675 degrees Fahrenheit. For example, multifaceted trivet 50 formed of silicone may protect a surface up to 675 degrees Fahrenheit, multifaceted trivet 50 formed of wood may be heat resistant up to 350 degrees Fahrenheit and a rattan version may be heat resistant up to 535 degrees Fahrenheit. The use of feet 36 adds greater heat resistance by allowing air to pass under the trivet and the serving dish 46. Particular embodiments may utilize feet 46 that are formed of silicone while multifaceted trivet 50 is formed of a different material, such as, but not limited to rattan, wood or ceramic. Silicone feet 36 would provide greater heat resistant particularly at the interface between multifaceted trivet 50 and the serving surface. Further, the materials from which multifaceted trivet 50 are formed may absorb heat to provide the heat protection from the serving surface. As mentioned previously, handles 56 may also comprise material that dissipates heat efficiently and effectively.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A trivet in combination with a container comprising:
a container;
a trivet having a top surface and bottom surface, said top surface having a lip and at least one handle coupled thereto and said bottom surface having feet;
wherein said trivet is configured to be placed over the container in a first position; and
wherein said container may rest on said trivet in a second position.

2. The trivet and container combination of claim 1, wherein said lip rests on sidewalls of the container with said feet fitting within the container in the first position.

3. The trivet and container combination of claim 1, wherein said feet rest on a serving surface in the second position.

4. The trivet and container combination of claim 1, wherein the top surface is a cutting board.

5. The trivet and container combination of claim 1, wherein the container is a serving dish.

6. The trivet and container combination of claim 1, wherein the container is a heated container.

7. The trivet and container combination of claim 1, wherein the at least one handle is substantially integrated.

8. The trivet and container combination of claim 1, wherein the at least one handle has an indented portion.
